(19) United States
(12) Patent Application Publication
(10) Pub. No.: US 2004/0181485 A1
(43) Pub. Date: Sep. 16, 2004

(54) System and method for check processing

(76) Inventors: Robert L. Finch, Ithaca, NY (US); Michael E. Caporali, Endicott, NY (US); Peggi J. Eller, Endicott, NY (US); Joan M. Marsh, Endwell, NY (US); Rosemary D. Paradis, Vestal, NY (US)

Correspondence Address: WOLF GREENFIELD & SACKS, PC, FEDERAL RESERVE PLAZA, 600 ATLANTIC AVENUE, BOSTON, MA, 02210-2211, US

(21) Appl. No.: 10/385,795

(22) Filed: Mar. 11, 2003

(51) Int. Cl. G06F 17/60

(52) U.S. Cl. 705/45

(57) ABSTRACT

A system and method for check processing is provided wherein a mailed check is received at a mail processing location, converted to electronic form, and electronically sent to the bank of first deposit. The mailed physical checks may be repackaged in envelopes and forwarded to the bank of first deposit. Because mailed checks are converted to electronic form at the mail processing facility, the delay before a bank of first deposit receives the check may be reduced.

### FIELD OF THE INVENTION

The present invention relates to the processing of checks, and more particularly to the electronic conversion of paper checks.

### DISCUSSION OF THE RELATED ART

In recent years, the number of checks written in the United States has grown steadily. Although other methods of non-cash payment are available, such as credit cards and debit cards, and have become increasingly widespread, paper checks have remained the dominant form of non-cash payment.

However, the cost to financial institutions of processing checks is significant. First, there are costs associated with converting the paper check to appropriate credit and debit transactions, transporting the check to the payer's bank, returning questioned items, and delivering checks to the payer.

A second cost associated with check processing is check float. When a payee of a check deposits the check at the bank of first deposit (BOFD), the check must be cleared with the financial institution of the payor. The payee's bank must wait until the check has been cleared with the payor's financial institution before the funds can be put to use on behalf of the payee's bank. Check float is the time between when a check is tendered in payment and when the funds are made available to the payee. The payor and the payor's bank may still be earning interest on the tendered funds while the check is being processed and cleared. As a result, delays in check processing can present a cost to the payee's financial institution in interest lost on the tendered money.

Related to costs associated with check float, is monetary float. As discussed above, it is desirable for the payee's bank to deposit funds from a check quickly and, if possible, before the payee has access to them. These unreleased funds are known as monetary float. Slow check processing can result in a reduction in the potential size of a bank's monetary float.

### SUMMARY OF THE INVENTION

According to one aspect of the invention, a method of checking processing is provided comprising the acts of a) receiving a mailed check at a mail processing location, b) converting the mailed check to electronic form, and c) electronically sending the electronic form of the mailed check to a Bank of First Deposit (BOFD). In one embodiment of the invention the method further comprises d) delivering the mailed check to the BOFD. In one embodiment of the invention, act b) further comprises b1) extracting the mailed check from a stream of mail, b2) removing the mailed check from a remittance envelope, and b3) converting selected information printed on the mailed check to electronic form.

In one embodiment of the invention, act d) further comprises d1) repackaging the mailed check in an envelope. According to another aspect of the invention act c) further comprises c1) electronically sending the electronic form of the mailed check to a collection location which collects a plurality of electronic forms of mailed checks intended for delivery to the BOFD, c2) grouping into a group the electronic form of the mailed check with the plurality of electronic forms of mailed checks, and c3) electronically sending the group to the BOFD.

According to one aspect of the invention, a method of check processing is provided comprising a) receiving a mailed check at a mail processing location, b) converting the mailed check to electronic form at the mail processing location without providing the mailed check to an external check truncation service, and c) electronically sending the electronic form of the mailed check to a Bank of First Deposit (BOFD). In one embodiment of the invention the method further comprises d) delivering the mailed check to the BOFD.

In one embodiment of the invention, act b) further comprises b1) extracting the mailed check from a stream of mail, b2) removing the mailed check from a remittance envelope, and b3) converting selected information printed on the mailed check to electronic form. In one embodiment of the invention, act d) further comprises d1) repackaging the mailed check in an envelope.

According to another aspect of the invention, act c) further comprises c1) electronically sending the electronic form of the mailed check to a collection location which collects a plurality of electronic forms of mailed checks intended for delivery to the BOFD, c2) grouping into a group the electronic form of the mailed check with the plurality of electronic forms of mailed checks, and c3) electronically sending the group to the BOFD.

In one embodiment of the invention, a method is provided wherein the act a) further comprises a1) grouping into a group of remittance checks the mailed check with a plurality of other mailed checks, and a2) sorting the group of remittance checks based on a destination of the check using a code printed on a remittance envelope of each mailed check.

According to one aspect of the invention, an apparatus for check processing comprises a mail sorter for removing an envelope having a check from a mail stream, a document extractor for removing the check from the envelope, an electronic converter for converting the check to electronic form, and a network formatter for converting the electronic form of the check to a format suitable for network transmission and transmitting the electronic form of the check over a computer network.

In one embodiment of the invention, the apparatus further comprises a database for storing information about a (Bank of First Deposit) BOFD of the electronic form of the check. According to another aspect of the invention, the apparatus further comprises f) a repackaging device for repackaging the check in an envelope and preparing the check for delivery to a Bank of First Deposit (BOFD).

These and other aspects and embodiments of the invention will be better understood and appreciated from a reading of the detailed description with reference to the accompanying drawings.

### BRIEF DESCRIPTION OF THE DRAWINGS

FIG. 1 is a flow chart illustrating an example of check processing through a clearinghouse;

FIG. 2 is a block diagram illustrating an example of electronic check distribution according to one embodiment of the invention;

FIG. 3 is a flow chart illustrating a method for check processing according to one embodiment of the invention; and

FIG. 4 is a block diagram illustrating an example of a check processing apparatus according to one embodiment of the invention.

### DETAILED DESCRIPTION

A paper check represents an instruction from the payor to his financial institution to pay the presenter, or payee, the amount specified by the check. As used herein a “check” may include a regular check related to a checking account, a money order, or any other instruction to transfer funds. Several models for settlement of checks exist. One model is known as an on-us transaction. In an on-us transaction, the payor and the payee use the same bank and all check processing operations are internal to that bank. For example, the bank could debit the account of the payor and credit the account of the payee.

A second model is known as an interbank agreement or direct presentment. This model typically occurs within a particular region or metropolitan area. In an interbank agreement, a bank may establish direct agreements with other banks, known as correspondent banks, to exchange checks drawn on each others' accounts.

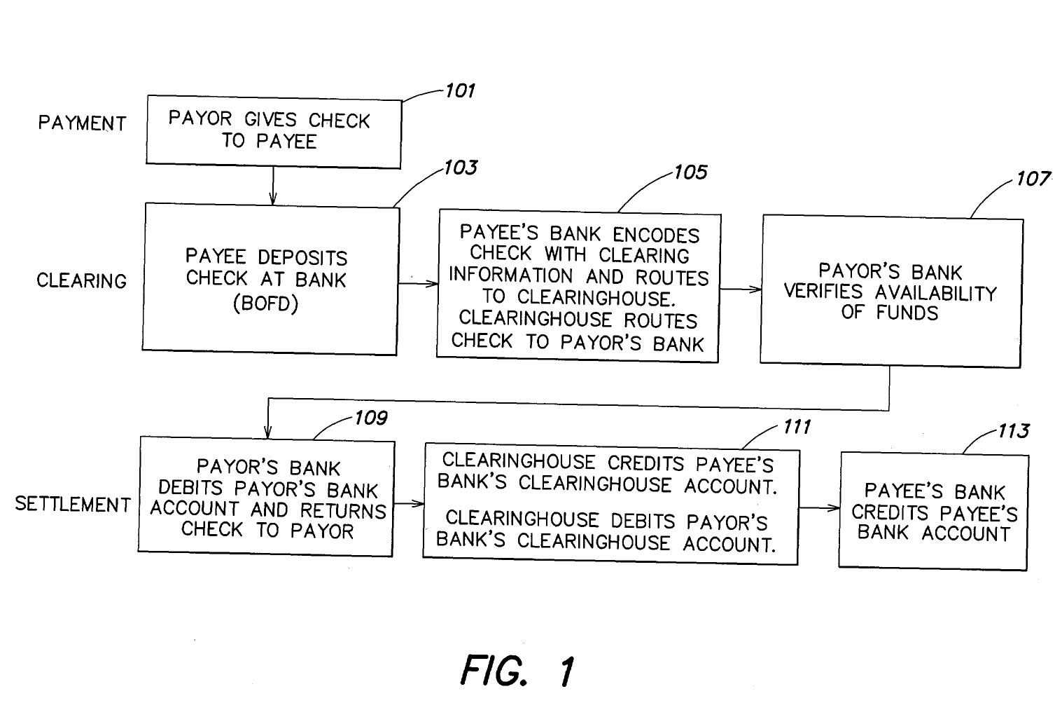

A third model is the clearinghouse model. Clearinghouses are independent banking organizations which settle checks between members. The Federal Reserve Bank is one example of a clearinghouse. Other clearinghouses include the American Clearing House and the Chicago Clearing House. The members of a clearinghouse are typically independent banking organizations. FIG. 1 is a flow diagram which illustrates the settlement of a check between two banks using a clearinghouse. At step 101, the payor presents the payee with a check. At step 103, the clearing process begins when the check enters the banking system at what is typically called the bank of first deposit (BOFD). At step 105, the check is encoded with clearing information.

Typically, the payment amount is added to the bottom of the check in a standardized location in machine-readable magnetic ink characters. The step of adding information to the checks may be performed, for example, by presenting each check to an operator who manually keys in the amount of the check, which is then imprinted by a machine on the check in the proper location. Alternatively, optical character recognition (OCR) technologies could be used, wherein an optical reader automatically reads the legal amount and the courtesy amount from the check and compares the two. The amount read by the OCR device and an image of the check may then be presented to a human operator, who verifies that the amount is correct. In this method, the amount only needs to be keyed in manually in case of an error.

Next, the check is routed to the clearinghouse. Typically, each bank which is a member of a clearinghouse has an account at that clearinghouse which can be credited and debited as funds are deposited in or drawn from the accounts of the bank's customers. The clearinghouse may then route the check to the payor's bank. At step 107, the payor's bank verifies that the funds are available. After the availability of funds have been verified, the settlement process may begin. At step 109, the payor's bank debits the payor's account. The clearinghouse may then credit the payee's bank clearinghouse account and debit the payor's bank's clearinghouse account (step 111). Finally, the payee's bank may credit the payee's account (step 113).

Processing a check can be expensive and time consuming, particularly when a paper check must be physically transported between several different locations. To reduce the cost and time of processing checks, methods of transferring check information electronically have been introduced. One method, called check truncation, includes scanning the paper check to make a digital image of the check, which can then be substituted for the paper check at a given point in the check processing cycle. For example, check truncation can occur at the point of sale using, for example, a document scanning apparatus for scanning checks. When a check is presented to a retail clerk in a point of sale payment, the retail clerk may insert the check into a scanning device, which creates an image of the check, reads the check, and creates an Automated Clearing House (ACH) electronic payment message. The cancelled check may then be returned to the customer and the ACH transaction debits the customer's bank account.

More typically, however, check truncation occurs after the check has entered the banking system at the BOFD. A BOFD is a financial institution which is responsible for depositing the check into a financial account. The process can occur in the back room of a bank branch, in a district or regional center for a group of branches, or even through a third party contractor. Often, a bank receives checks in large volumes through remittance mail. Large volume remittance mail is typically processed at a central bank or check processing center.

Another method of electronic check clearance and settlement is known as electronic check presentment (ECP). Although ECP is not dependent on check imaging, the two may be used in conjunction. In an ECP transaction, the magnetic ink character recognition (MICR) line information, including the amount of the check, is sent electronically to the payor's bank. Multiple checks to the same bank can be sent in electronic form in an Electronic Cash Letter (ECL). The payor's bank can then decide whether to honor a check or reject it, based on receipt of the electronic form of the check.

Several different models of ECP can be used. In one model called ECP with Paper to Follow, transmission of the check in electronic form allows check processing to begin, but the paper checks must still be transported back to the payor's bank. In a second model, known as Image Cash Letter, paper checks can be completely replaced with an electronic file containing both ECP data and related check images. In another model, known as Image to Follow, ECP data is sent first over telecommunications media. The check image data is sent separately, typically using a lower cost medium such as magnetic tape. Another ECP transaction model is called Image on Request. In this method, only the ECP data is sent and check images are provided only on request. The BOFD typically is responsible for the archival and storage of check, but the payor's bank statements contain neither the paper checks nor their images.

Although electronic check clearing and settlement methods such as check truncation, ACH, and ECP may reduce the time and cost of the check processing by reducing the need for paper checks, there may still be a large delay between when a check is written by a payor and when it is received by the BOFD, for example, delay in the postal system. The time required to send the check through the mail can often be greater than the combined time required to complete each of the other check processing steps.

To reduce the time that a check spends in the mail, payors may be provided with remittance envelopes, on which are printed a special bar code. When the mailed remittance envelopes arrive at a particular mail processing facility, such as a United States Postal Service (USPS) Processing and Distribution Center (P&DC), they can be sorted out of the mail stream using the special bar code printed on the front. The remittance envelopes may then be placed in a special holding area to be picked up by their intended recipients. The recipients, typically large banks, can send runners to the P&DC to pick up the remittance envelopes and deliver the checks to the check processing facility. Because this method does not require local delivery of the remittance mail, the delivery time can be reduced. However, by the time the remittance envelopes are sorted out of the mail stream at the P&DC they have typically already been in the mail for two or more days and may also have already been processed through another P&DC.

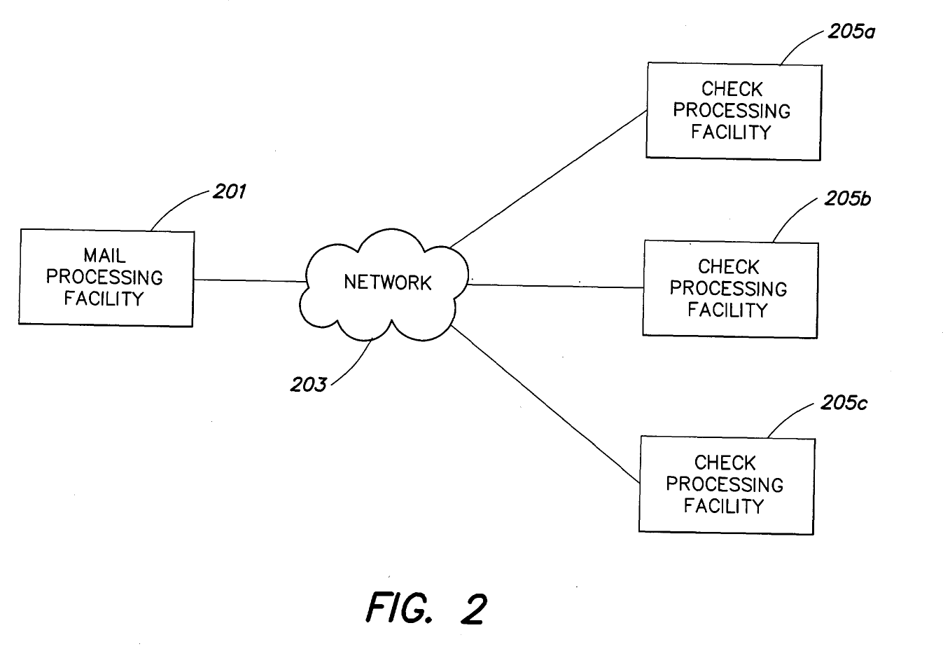

In order to expedite the transfer of checks to their recipients, conversion of the check to electronic form can be preformed at a mail processing facility. The electronic form of the check can then be sent to a check processing facility of the recipient. As shown in FIG. 2, mail processing facility 201 sorts checks out of the mail stream and converts them to electronic form. The electronic form of the check is then sent over a communications network 203 to an appropriate check processing facility 205. A mail processing facility may be any facility which assists with the sorting and distribution of mail. For example, a mail processing facility may be a USPS P&DC, a USPS Post Office Branch, or the processing facilities of courier services, and package delivery services such as Federal Express and UPS. A check processing facility may be the BOFD of the check or a check processing center.

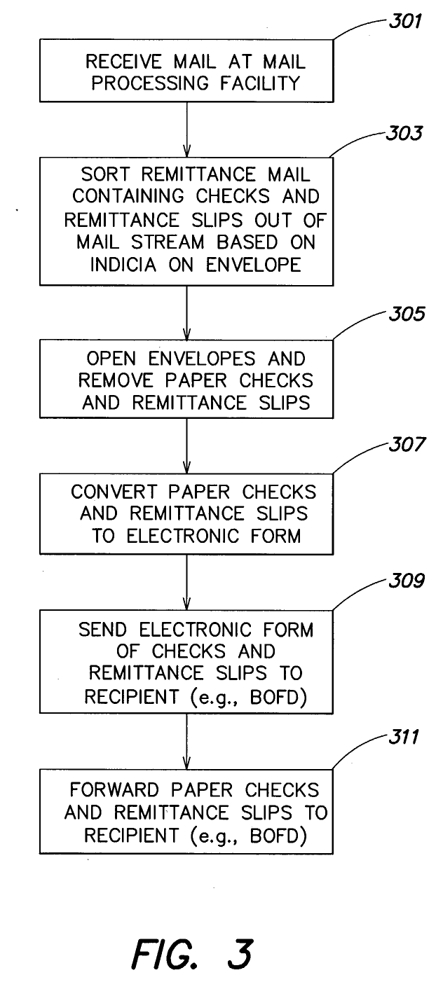

FIG. 3 illustrates the process of performing electronic conversion of paper checks received at a mail processing facility, Step 301 according to one embodiment of the invention. As shown at step 303, mail may be sorted out of the regular mail stream at the mail processing facility using a special computer-readable code printed on the envelope. The code may be, for example, a bar code, magnetic ink, or a radio tag. Any type of computer-readable code may be used. The code may not only indicate that a remittance envelope contains a check and remittance slip and should be sorted out of the mail stream, but may also indicate the intended recipient of the check. For example, the code on a first envelope may indicate that the first envelope should be sorted out of the mail stream and the intended recipient is Bank A, while the code on a second envelope indicates that the second envelope should be sorted out of the mail stream and the intended recipient is Bank B. An example of a code that may be used is a USPS PLANET bar code.

At step 305, the remittance envelopes are opened and the checks and remittance slips are removed. This process can be performed either manually or automatically. If performed automatically, any suitable document extraction device could be used. Next, the checks and remittance slips may be converted to electronic form and sent to the appropriate BOFD, based on the code from the original envelope (Steps 307 & 309). For example, an electronic image may be made of both sides of the check and remittance slips. These electronic images may then be sent to the BOFD. Then, at step 311, the paper checks and remittance slips associated with each BOFD may be collected and forwarded to the appropriate BOFD or check processing center. That is, the checks and remittance slips may be repackaged in envelopes, addressed, and forwarded to BOFDs. It should be appreciated that all checks going to the same location may be packaged together at the end of the day or at the end of a selected period of time. Alternatively, each check may be packaged individually in a separate envelope and sent after being converted to electronic form. At step 311, the paper checks are forwarded to the appropriate bank of first deposit. As mentioned above, step 311 may occur at the end of the day, such that all checks and remittance slips for a day may be collected and forwarded to the appropriate BOFD. Alternatively, step 311 could occur once every other day, twice a day, or at any other suitable interval.

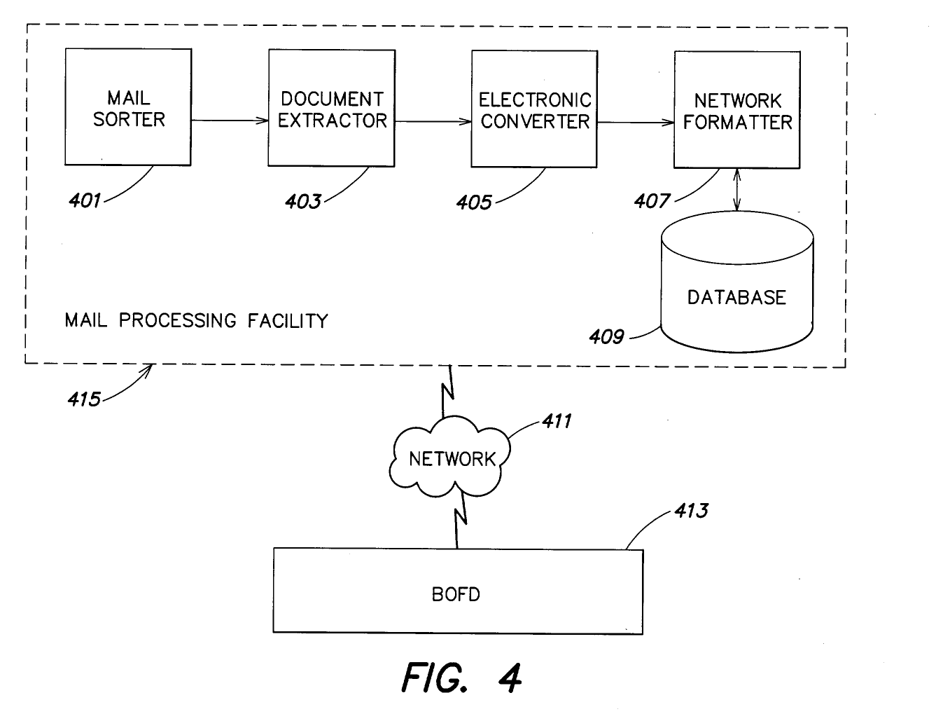

FIG. 4 depicts generally an apparatus for performing electronic conversion of checks at a mail processing facility according to one embodiment of the invention. FIG. 4 illustrates a mail processing facility 415, which includes a mail sorter 401, a document extractor 403, an electronic converter 405, a network formatter 407, and a database 409. Blocks 401, 403, 405, 407, and 409 are depicted as separate pieces in FIG. 4 for the purposes of illustration. However, these blocks may be combined in any manner into one or more separate devices. Electronic data can be transferred over a network 41 1 from the mail processing facility 415 to a BOFD 413.

In operation, Mail Sorter 401 identifies envelopes marked with the computer-readable code, such as the PLANET bar code described above, and removes these envelopes from the mail stream. Alternatively, a human-readable code could also be used to allow human operators to remove the envelopes from the mail stream and check for errors in the sorting process. The information obtained from the code may be stored electronically and the envelopes may be sent to Document Extractor 403, which removes checks and remittance slips from the envelopes. Because the information from the code on the envelopes may be stored electronically, the envelopes may be discarded at this point.

Next, the checks may be sent to Electronic Converter 405 which converts the checks to electronic form. The Electronic Converter may create a digital image of both sides of the check and remittance slips. The digital image may use any suitable image format. The image format may be a compressed format or non-compressed format. For example, the image format may be JPEG, TIFF, GIF, or any other suitable image format. Alternatively, Electronic Converter 405 may read the MICR information from the check and may also read the check amount, for example using OCR. Electronic Converter 405 could also encode the check amount in magnetic ink in the designated position. Electronic Converter 405 could provide this MICR information along with the digital image of the check to Network Formatter 407. Thus, the electronic form of the check provided by Electronic Converter 405 could include the digital image of the check and the MICR information and check amount, or could simply include the digital image of the check without the MICR information.

Electronic Converter 405 provides the electronic form of the check to Network Formatter 407. Network Formatter 407 functions to convert the electronic format of the check to a format suitable for transmission over Network 411. For example, if Network 411 is an Internet Protocol (IP) network, Network Formatter 407 may convert the electronic form of the check to IP packets. If Network 411 is, for example, a Fibre Channel network, Network Formatter may convert the electronic form of the check to a format suitable for transmission according to the Fibre Channel protocol. Any type of network protocol or networking media may be used.

Additionally, Network Formatter may group electronically formatted checks going to the same BOFD together and transmit the entire group together. For example, electronically formatted checks may be transmitted to a given BOFD when a predetermined number of checks have been received at the mail processing facility or may be transmitted at a given time interval, for example every hour. Electronically formatted checks may be stored in database 409 between transmission intervals.

As mentioned above, the information from the code on the envelopes may be stored electronically. The code may indicate a network address to which a check should be sent. Database 409 may maintain a map which indicates a correspondence between code information and network addresses. Before transmitting electronically formatted checks over the network, the proper network address to which those checks should be sent may be looked up in Database 409. The network address may be the network address of a check processing facility which can receive the check in electronic form, perform image based MICR reading and encoding of the electronic form of the check, and send the check information to a clearinghouse or correspondent bank, using, for example, an ECL or ACH payment.

Paper checks and remittance slips may then be collected, as discussed above, and forwarded to the appropriate BOFD.

As a result, the delivery time of the check from the payer to the BOFD may be reduced because it is not necessary to wait for physical delivery of the paper check to begin check clearing and settlement.

Having thus described various embodiments of the present invention, additional alterations, modifications, and improvements will readily occur to those skilled in the art. Accordingly, the foregoing description is by way of example only, and not intended to be limiting. The invention is limited only as defined in the following claims and the equivalence thereto.

What is claimed is:

1. A method of check processing comprising acts of:
a) receiving a mailed check at a mail processing location;
b) converting the mailed check to electronic form at the mail processing location; and
c) electronically sending the electronic form of the mailed check to a Bank of First Deposit (BOFD).

2. The method of claim 1, further comprising:
d) delivering the mailed check to the BOFD.

3. The method of claim 1, wherein the act b) further comprises:
b1) extracting the mailed check from a stream of mail;
b2) removing the mailed check from a remittance envelope; and
b3) converting selected information printed on the mailed check to electronic form.

4. The method of claim 2, wherein the act d) further comprises:
d1) repackaging the mailed check in an envelope.

5. The method of claim 1, wherein the act c) further comprises:
c1) electronically sending the electronic form of the mailed check to a collection location which collects a plurality of electronic forms of mailed checks intended for delivery to the BOFD;
c2) grouping into a group the electronic form of the mailed check with the plurality of electronic forms of mailed checks; and
c3) electronically sending the group to the BOFD.

6. The method of claim 3, wherein the act b1) further comprises:
identifying the mailed check in the stream of mail, using code printed on the remittance envelope;

7. The method of claim 3, wherein the act b3) further comprises:
automatically reading the selected information from the mailed check; and
manually verifying at least some of the selected information automatically read from the mailed check.

8. The method of claim 1, wherein the act a) further comprises:
a1) grouping into a group of remittance checks the mailed check with a plurality of other mailed checks; and
a2) sorting the group of remittance checks based on a destination of the check using a code printed on a remittance envelope of each mailed check.

9. The method of claim 5, wherein the act c3) further comprises:
sending the group to the BOFD in encrypted form.

10. A method of check processing comprising:
a) receiving a mailed check at a mail processing location;
b) converting the mailed check to electronic form at the mail processing location without providing the mailed check to an external check truncation service; and
c) electronically sending the electronic form of the mailed check to a Bank of First Deposit (BOFD).

11. The method of claim 10, further comprising:
d) delivering the mailed check to the BOFD.

12. The method of claim 10, wherein the act b) further comprises:
b1) extracting the mailed check from a stream of mail;
b2) removing the mailed check from a remittance envelope; and
b3) converting at least some information appearing on the mailed check to electronic form.

13. The method of claim 11, wherein the act d) further comprises:
d1) repackaging the mailed check in an envelope.

14. The method of claim 10, wherein the act c) further comprises:
c1) electronically sending the electronic form of the mailed check to a collection location which collects a plurality of electronic forms of mailed checks intended for delivery to the BOFD;
c2) grouping into a group the electronic form of the mailed check with the plurality of electronic forms of mailed checks; and
c3) electronically sending the group to the BOFD.

15. The method of claim 12, wherein the act b1 further comprises:
identifying the mailed check in the stream of mail, using a code printed on the remittance envelope;

16. The method of claim 12, wherein the act b3) further comprises:
automatically reading the selected information from the mailed check; and
manually verifying at least some of the selected information automatically read from the mailed check.

17. The method of claim 10, wherein the act a) further comprises:
a1) grouping into a group of remittance checks the mailed check with a plurality of other mailed checks; and
a2) sorting the group of remittance checks based on a destination of the check using a code printed on a remittance envelope of each mailed check.

18. The method of claim 14, wherein the act c3) further comprises:
sending the group to the BOFD in encrypted form.

19. An apparatus for check processing comprising:
a) a mail sorter for removing an envelope having a check from a mail stream;
b) a document extractor for removing the check from the envelope;
c) an electronic converter for converting the check to electronic form;
d) a network formatter for converting the electronic form of the check to a format suitable for network transmission and transmitting the electronic form of the check over a computer network.

20. The apparatus of claim 19, further comprising:
e) a database for storing information about a Bank of First Deposit (BOFD) which is the recipient of the electronic form of the check.

21. The apparatus of claim 19, further comprising:
f) a repackaging device for repackaging the check in an envelope and preparing the check for delivery to a Bank of First Deposit (BOFD).

22. A system for checking processing comprising:
a) means for receiving a mailed check at a mail processing location;
b) means for converting the mailed check to electronic form; and
c) means for electronically sending the electronic form of the mailed check to a Bank of First Deposit (BOFD).

23. The system of claim 22, further comprising:
d) means for delivering the mailed check to the BOFD.

24. The system of claim 22, wherein b) further comprises:
b1) means for extracting the mailed check from a stream of mail;
b2) means for removing the mailed check from a remittance envelope; and
b3) means for converting selected information printed on the mailed check to electronic form.

25. The system of claim 23, wherein d) further comprises:
d1) means for repackaging the mailed check in an envelope.

26. The system of claim 22, wherein c) further comprises:
c1) means for electronically sending the electronic form of the mailed check to a collection location which collects a plurality of electronic forms of mailed checks intended for delivery to the BOFD;
c2) means for grouping into a group the electronic form of the mailed check with the plurality of electronic forms of mailed checks; and
c3) means for electronically sending the group to the BOFD.
